(19) United States
(12) Patent Application Publication
(10) Pub. No.: US 2013/0143181 A1
(43) Pub. Date: Jun. 6, 2013

(54) IN-VEHICLE TRAINING SYSTEM FOR TEACHING FUEL ECONOMY

(71) Applicants: Jeff Allen Greenberg, Ann Arbor, MI (US); Dean Mengel, Livonia, MI (US); Les R. Bodnar, Dearborn, MI (US); Sonya Nematollahi, Rochester Hills, MI (US); Fling Tseng, Ann Arbor, MI (US)

(72) Inventors: Jeff Allen Greenberg, Ann Arbor, MI (US); Dean Mengel, Livonia, MI (US); Les R. Bodnar, Dearborn, MI (US); Sonya Nematollahi, Rochester Hills, MI (US); Fling Tseng, Ann Arbor, MI (US)

(73) Assignee: FORD GLOBAL TECHNOLOGIES, LLC, Dearborn, MI (US)

(21) Appl. No.: 13/310,823

(22) Filed: Dec. 5, 2011

(51) Int. Cl. G09B 9/04

(52) U.S. Cl. 434/62

(57) ABSTRACT

The present disclosure discloses a method for teaching fuel economy in a vehicle. The method includes activating an in-vehicle training mode and sending an instruction set for an initial vehicle maneuver. By calculating the fuel economy during the initial vehicle maneuver, an optimized speed/acceleration profile is computed. Subsequent vehicle maneuvers are initiated, and the speed/acceleration profiles computed during subsequent vehicle maneuvers are compared to the optimized speed/acceleration profile. Corrective feedback is generated during subsequent vehicular maneuvers upon deviations from the optimized speed/acceleration profile.

### FIELD OF THE INVENTION

This application relates generally to the field of improvements in vehicular fuel economy, and more particularly to systems for training drivers how to achieve improved fuel economy.

### BACKGROUND

Depleting fuel reserves, rising fuel costs and tighter emission norms worldwide have led to an increased awareness among vehicle owners and manufacturers of the need to conserve energy resources. Fuel economy, as a result, has become a major concern for many vehicle owners and manufacturers.

Many of the factors that contribute to excessive fuel consumption are related to the total weight of the vehicle, engine capacity, engine or vehicular design, etc. One aspect of excessive fuel consumption, however, lies in an individual's driving behavior, which is often overlooked.

An individual's driving pattern may vary over time and may periodically cause excessive throttle movement and improper braking during acceleration or cruise maneuvers. Such a condition may not only cause discomfort to the vehicle's occupants but also may contribute significantly to excessive fuel consumption leading to the depletion of the vehicle's fuel supply.

Currently, quantities of training materials and modules for training drivers are available on the internet and in other media. None of these materials, however, teaches an efficient way of controlling the throttle and brake pedals to improve fuel economy. Smooth throttle control and steady braking are teachable skills that can be learned with the correct course of instructions. The solution lies in a real time driver coaching or teaching method.

Certain online fuel economy improvement systems incorporate driver feedback systems to provide a clear conspicuous negative or a positive feedback to guide the driver's performance. Negative feedback, such as a buzzer, may be intrusive and can cause excessive driver distraction and discomfort. Positive feedback, on the other hand may be limited in effectiveness since an optimized learning would require an indication of when the driver has deviated from an optimized driving pattern.

Presently, no solution exists to teach and train a driver to improve her fuel efficiency. It would be desirable to have a driver's training system, which is operated from within vehicular confines, enabling real time learning and thereby improving overall fuel economy. That need is the subject of the present disclosure.

### SUMMARY

One embodiment of the present application describes a fuel economy teaching method by activating an in-vehicle training mode. The method includes sending an instruction set for an initial vehicle maneuver and calculating the fuel economy during the initial vehicle maneuver. Further, computing of an optimized speed/acceleration profile based on the fuel economy during the initial maneuver is performed, initiating subsequent vehicle maneuvers. By comparing the speed/acceleration profiles computed during subsequent vehicle maneuvers to the optimized speed/acceleration profile, corrective feedbacks are generated, upon deviations of the subsequent speed/acceleration profile from the optimized speed/acceleration profile.

Another embodiment of the present application discloses an in-vehicle fuel economy teaching system having an interactive module, configured to send a set of initial instructions for an initial vehicular maneuver, and initiate subsequent vehicular maneuvers, as well. A calculating module calculates the vehicle's fuel economy during the initial and subsequent maneuvers. A computing module is configured to compute an optimized speed/acceleration profile based on the fuel economy during the vehicle's initial maneuver, and is further configured to generate speed/acceleration profile during subsequent maneuvers. During subsequent maneuvers, a comparison module compares the subsequent speed/acceleration profiles to the optimized speed/acceleration profile, and generates corrective feedback through a feedback interface, upon deviations from the optimized speed/acceleration profile.

Certain embodiments disclose a vehicular fuel economy training system that comprises an interactive module configured to send an instruction set for an initial vehicular maneuver, and further initiate subsequent vehicular maneuvers. A calculating module incorporated, calculates the fuel economy during initial and subsequent vehicle maneuvers. Subsequently, a computing module generates an optimized speed/acceleration profile based on fuel economy during the initial maneuver, and generates similar speed/acceleration profiles during subsequent maneuvers. A comparison module compares the subsequent speed/acceleration profiles to the optimized speed/acceleration profile by generating corrective feedbacks through a feedback interface during subsequent maneuvers. Such feedbacks are generated upon deviations of the subsequent speed/acceleration profiles from the optimized speed/acceleration profile during subsequent maneuvers. Summarization of the imparted training is established at the end of the training

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates an exemplary embodiment of an in-vehicle fuel economy training system.

FIG. 2 is a flowchart illustrating an exemplary method for training a driver for fuel economy improvement.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes methods and systems for an in-vehicle fuel training system to teach fuel economy. To this end, the embodiments of the present disclosure employ multiple intelligently functioning modules within the training system. Such modules function inter-actively to instruct the driver to execute an initial maneuver. A calculating module calculates the fuel economy for this maneuver, and subsequently feeds this information to a computing module that analyses the speed/acceleration profile and determines an optimized speed/acceleration profile. Once such a profile is obtained, subsequent vehicular maneuvers are prompted during which the speed/acceleration profiles are compared to the optimized speed/acceleration profile. A comparison module compares and processes the generation of corrective feedbacks upon deviations from the optimized driving profile, imparting driving skills. Before exiting the system, a summary is generated depicting the driver's performance and improvements based on fuel economy during subsequent maneuvers, helping develop an improved driving behavior.

### Exemplary Embodiments

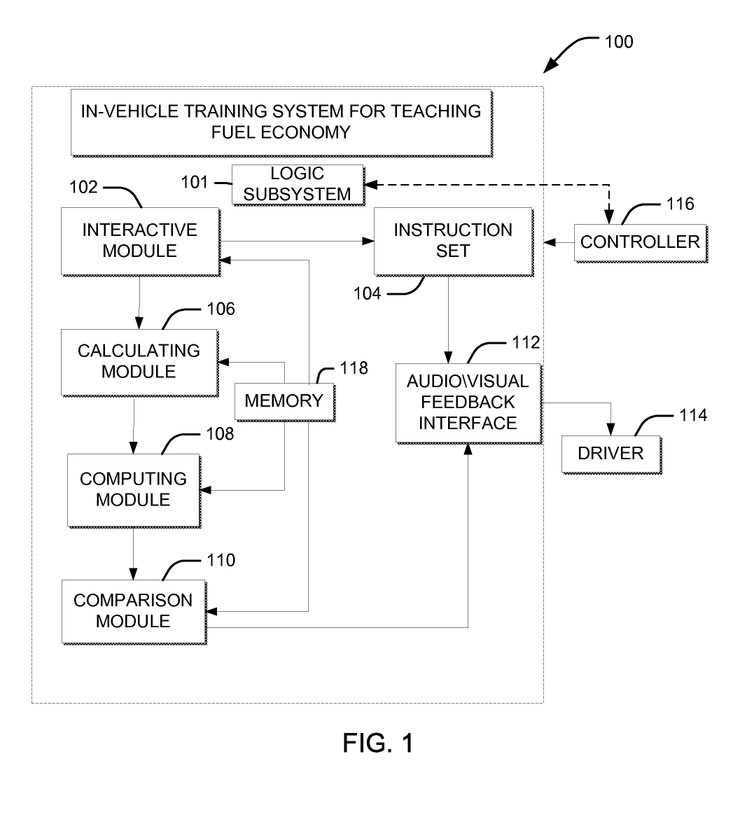

FIG. 1 schematically depicts an in-vehicle fuel economy training system 100 configured as an in-vehicle fuel economy teaching system for a driver 114. The training system 100 generally includes a logic subsystem 101, a built-in memory device 118, and a set of inter-operational modules. The module set includes an interactive module 102, a calculating module 106, a computing module 108, and a comparison module 110. A controller 116 provides directions for the system 100, and an audio/visual feedback interface 112 enables establishment of audio/visual communications.

Within the training system 100, the logic subsystem 101 may be configured to form or generate an instruction set 104, which is formed as a part of a built-in program or other logical input. The instruction set 104 may be communicated to the driver 114 either in an audible format, visual format, or through a combination of these two formats, and may be implemented to perform a task, or otherwise arrive at a desired result. The logic subsystem 101 may include one or more processors that are configured to execute software instructions obtained through inputs initiated by the driver 114. Importantly, the logic subsystem 101 is linked to the controller 116 to control the flow of data from one module to the next.

The interactive module 102 is configured to send information to the driver 114 and collect feedback from her, using the audio/visual feedback interface 112. The information passed to the driver 114 includes the pre-determined instruction set 104. The interactive module 102 is configured to receive certain inputs manually or via voice commands from the driver 114, and after receiving that information, the interactive module 102 enabled to send out corresponding output signals in varied forms. In the illustrated embodiment, this module provides information through visual or audible means via the feedback interface 112. More particularly, the feedback interface 112, positioned on the vehicle's dashboard, may include a screen, set of speakers, mouthpiece etc.

Vehicular throttle positions, brake pedal positions etc, may also form inputs sensed by sensing units such as pressure or proximity sensors, linked with the computing module 108 during driving maneuvers, as set out below. These inputs once computed via the computing module 108 and processed by the comparison module 110, assists in forming outputs that are fed to the interactive module 102. The driver 114 receives such output through the feedback interface 112 via visual or audible means, or both. The specific nature of the user interface of the interactive module 102 will be governed by conventional design choices for controls and instruments in a specific vehicle, and such are known to those skilled in the art.

Calculating module 106, as shown, performs mathematical calculations related to the vehicular fuel economy during the training procedures. It may include one or more processors for carrying out such calculations. Factors required for calculating vehicular fuel economy include fuel consumption figures and the distance travelled by the vehicle during an initiated training maneuver. Fuel consumption figures are obtained by employing a fuel gauge in the vehicle's fuel lines, measuring and extracting data related to the exact amount of the fuel consumed during a particular maneuver. Accordingly, the calculating module 106 is linked to the fuel gauge and the vehicle's odometer during the training procedures. Data retrieval from such components forms the input to calculate the fuel economy figures of the vehicle during the maneuver. Fuel economy figures thus obtained are fed to the computing module 108.

Engaged with the calculating module 106, the computing module 108 computes and develops speed/acceleration profiles for vehicular maneuvers based on their fuel economy. Such an application requires one or more processors within the computing module 108 to carry out the computational task. To form speed/acceleration profiles, the system 100 extracts information actions performed during the maneuvers, such as variations in pressure and position of the throttle, brake, and clutch, as well as gear changes during the driving maneuvers. Extraction and delivery of such information to the computing module 108 may be performed through sensing units, such as pressure or proximity sensors, linked via cables to the computing module 108.

Importantly, the computing module 108 is also configured to compute and form an optimized speed/acceleration profile based on the fuel economy during specific vehicular maneuvers. The optimized profile thus obtained offers an improved driving pattern than a pattern generally followed, enabling the driver 114 to change the manner and no degree that the accelerator, brake, or clutch pedals are depressed. Driving factors significantly affecting vehicle's fuel economy such as pedal pressures and frequency of pedal and gear operation may thus be addressed and improved.

It will be understood that fuel economy depends not only on the driving behavior of an individual, but may also depend on the usage of in-vehicular facilities. The engine functions as a source of energy for all in-vehicular functionalities of accessories and equipments, such as air conditioning systems etc. Improper usage of such provisions may significantly affect fuel economy. Fuel consumed by such equipment may also be sensed and monitored by employing appropriate sensing units in a fashion similar to as disclosed, retrieving information related to the fuel consumed by them. Fuel consumption figures obtained, as a result, may be processed and may enable optimized utilization of such in-vehicular facilities as well.

The comparison module 110, being the last of the inter-operational modules, comprises at least one or more processors to enable comparison of the speed/acceleration profiles of vehicular maneuvers to the optimized profile, and generates a corresponding compared value. The comparison module 110 is configured to subsequently feed this compared value to the feedback interface 112, providing the driver 114 with a corrective feedback either in an audible format, visual format, or in a combination of these formats.

Controller 116 is configured to deactivate the training system 100 upon the vehicle exceeding a predetermined speed threshold. The controller 116 may be a microprocessor based control system adapted for actively controlling the training activity, and it may include appropriate input and output circuits of a known type for receiving input signals and for transmitting the various commands to the actuators associated with the modules. Sensing units such as proximity or pressure sensors positioned at the throttle pedal could provide the required information to the controller 116.

The training system 100 includes the built-in memory device 118 configured to be linked to all the modules, storing and maintaining all training-related information during a training activity. Accordingly, memory device 118 may be configured to hold the initial instruction set 104, default voice/visual commands, speed acceleration profiles, on-going calculations, and computations of driving patterns, etc. Memory device 118 could comprise dual potions of volatile or non-volatile memory for both temporary and permanent storage of information.

The system set out above operates to generate and execute a program designed to assist drivers in improving fuel efficiency. That system operates as follows.

The driver 114 initiates the in-vehicle fuel economy training system 100, and an in-vehicle training mode is thus activated. Such activation may be enabled through manually operated switching means or through appropriate voice commands. Similar voice commands or switching means may also enable manual deactivation of the training system 100. The feedback interface 112 may enable establishment of communications based on visual and/or voice commands.

Upon activation, the interactive module 102 verifies through the driver 114 that the vehicle is parked in an appropriate location, such as a parking lot, racetrack etc., where a simple acceleration/cruise/stop maneuver could be carried out. That verification may be performed through a preset questionnaire stored in the system's built-in memory device 118. Once such verification is carried out, the interactive module 102 sends out the instruction set 104 to carry out an initial vehicular maneuver, through an audible and/or visual format.

Based on the instructions received from the system 100, the driver 114 begins operating the vehicle in a training mode. As a first vehicular maneuver, the driver 114 may be instructed to accelerate to a preset speed of 20 mph within a certain period. Once the desired speed is attained, another instruction could be generated through the interactive module 102, prompting the driver 114 to cruise for a preset period of 10 seconds at 20 mph. After 10 seconds, a third instruction could command the driver 114 to decelerate, asking him to eventually stop and park the vehicle in a safe spot. An initial maneuver is thus accomplished. That set of commands and responses constitutes an initial training maneuver.

The calculating module 106 calculates the fuel economy achieved during the initial maneuver and compares the results with results from other drivers, or possibly with preset data. That comparison indicates whether the driver's optimized speed/acceleration profile falls within the driver's tolerance for error. Further, the computing module 108 computes and establishes an optimized speed/acceleration profile based on the fuel economy during the initial maneuver. Once such a profile is established, the interactive module 102 initiates and instructs the vehicle to be driven for subsequent set of maneuvers. The calculating module 106 calculates the fuel economy during such subsequent maneuvers as well.

The comparison module 110 comes into play during the subsequent maneuvers, and begins comparing the speed/acceleration profiles of the subsequent maneuvers, also computed via the computing module 108, to the established optimized speed/acceleration profile. A deviation of the subsequent speed/acceleration profiles from the established optimized speed/acceleration profile yields a corrective feedback signal through the feedback interface 112. That feedback may be transmitted through an audible and/or visual format to the driver 114. An audible feedback, such as noted above, may be received by the driver 114 as variations in loudness, sharpness, or frequency, from a selected baseline sound.

Importantly, a summary of the entire training and the speed/acceleration profiles is established before exiting the training system 100. The summary may be communicated to the driver 114 through an audible feedback, visual display, or some combination of those two methods.

To this end, the controller 116 utilizes a decision logic that monitors a set of conditions associated with the driver 114 and consequently exits the training mode upon the driver 114 exceeding a predetermined speed threshold.

Alternatively, the training system 100 may allow provisions for documenting and storing the obtained summary on the built-in memory device 118 in the vehicle. Further, the generated summary document may also be transferable to a personal computer, hand-held electronic portable devices, smart phones, and thus be accessible via personal mail.

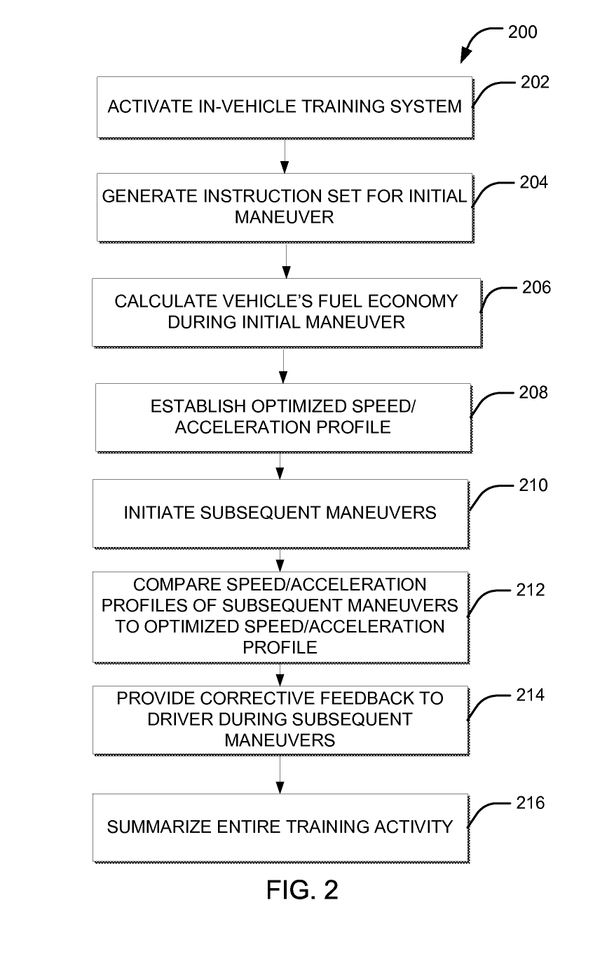

FIG. 2 illustrates an exemplary fuel economy teaching method 200 for carrying out an in-vehicle training, teaching fuel economy in accordance with the present disclosure. The methodology presented here through a flowchart is identical to the methodology discussed in connection with FIG. 1.

At step 202, the system 100 activates an in-vehicle training mode as part of the training system 100. The driver 114 or operator performs this step either through a voice command or through manual switching means disposed within the vehicle.

At step 204, the interactive module 102 verifies the location to be suitable for conducting vehicle training Examples of such locations are parking lots, open field, race tracks etc. Subsequently, the interactive module 102 sends the instruction set 104 to the driver 114 to follow. Sending the instruction set 104, such as noted, may be established, either through audible means, through a visual display, or both. The instruction commands the driver 114 to accelerate the vehicle at a fixed rate of speed for a predetermined period, after which the system 100 issues a voice command for the driver 114 to proceed at a fixed speed for a period, and eventually decelerate at a fixed rate until the vehicle stops. All communications, as noted, are enabled through the feedback interface 112 comprised within the teaching method 200.

Once such an initial maneuver is accomplished, at step 206, the calculating module 106 calculates the fuel economy for the maneuver. The calculated fuel economy figure is then fed to the computing module 108. There, the speed/acceleration profile for the initial maneuver is analyzed, based on the fuel economy, and then an optimized speed/acceleration profile is computed, all in step 208. Next, in step 210, interactive module 102 instructs the driver 114 to initiate a number of subsequent vehicle maneuvers. As those maneuvers are accomplished, the system 100 executes step 212, in which the comparison module 110 compares the speed/acceleration profiles computed during subsequent maneuvers to the optimized speed/acceleration profile. Subsequently, at step 214, corrective feedback is generated in an audible and/or visual format in case of deviations of the subsequent speed/acceleration profiles from the optimized speed/acceleration profile, during the maneuver.

During these maneuvers, corrective feedback is provided to the driver 114 as variations in loudness, sharpness or frequency from a pleasing baseline sound. An option to switch between a visual format in place of an audible signal can be incorporated if desired. More particularly, corrective feedbacks can be provided to the driver 114 as a combination of audible and visual formats, as well. Other variations in the manner of feedback will be apparent to those of skill in the art. Finally, at step 216, a summary of the entire training process is generated by the comparison module 110 and provided to the driver 114 before exiting the training mode.

Alternatively, training system 100 may enable an optimized speed/acceleration profile to be stored in the system's built-in memory device 118, and retrieved during desired occasions. Such a provision could enable the driver 114 to learn and apply proper driving techniques and behavioral patterns even during normal driving cycles. Corrective feedback could thus be generated even while the vehicle is operating outside the training mode, as disclosed. Such functionality would be applicable especially during varied road conditions, traffic, vehicular loading etc., effectively improving the driving behavior and enhancing the vehicle's fuel economy during specific conditions.

In another embodiment, the training system 100 could be configured as a portable unit or a kit, providing for an easy transfer between multiple vehicles for a set of applications.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A fuel economy teaching method comprising:
activating an in-vehicle training mode;
sending an instruction set for an initial vehicle maneuver;
calculating the fuel economy during the initial vehicle maneuver;
computing an optimized speed/acceleration profile based on the fuel economy during the initial maneuver;
initiating subsequent vehicle maneuvers;
comparing the speed/acceleration profiles computed during subsequent vehicle maneuvers to the optimized speed/acceleration profile; and
generating corrective feedbacks during subsequent vehicular maneuvers upon deviations from the optimized speed/acceleration profile.

2. The method of claim 1 further comprising a feedback interface for establishing audio/visual communications.

3. The method of claim 1, wherein the instruction set and the corrective feedback is communicated using one of:
an audible format;
a visual format; or
a combination of the audible and visual formats.

4. The method of claim 1, wherein a summary of the speed/acceleration profiles of subsequent vehicle maneuvers is established before exiting the training mode.

5. The method of claim 4, wherein the summary established is communicated using at least one of:
visual display;
audible feedback; or
a combination of the visual display and audible feedback.

6. The method of claim 1, wherein the fuel economy teaching method is deactivated either upon:
exceeding the vehicular speed threshold limit; or
manual deactivation.

7. An in-vehicle fuel economy teaching system comprising:
an interactive module, configured to send a set of initial instructions for an initial vehicular maneuver, and initiate subsequent set of vehicular maneuvers;
a calculating module, configured to calculate the fuel economy achieved by the vehicle during the initial maneuver and subsequent maneuvers;
a computing module, configured to compute and establish an optimized speed/acceleration profile based on the achieved fuel economy during the initial maneuver, and
generate speed/acceleration profiles based on the fuel economy during the subsequent maneuvers; and
a comparison module, configured to compare the subsequent speed/acceleration profiles to the optimized speed/acceleration profile, and
generate corrective feedback through a feedback interface, upon deviations of the subsequent speed/acceleration profiles from the optimized speed/acceleration profile during subsequent vehicle maneuvers.

8. The system of claim 7, wherein the feedback interface enables establishment of audio/visual communications.

9. The system of claim 7, wherein the interactive module communicates the instruction set and the corrective feedback using at least one of:
an audible format;
a visual format; or
a combination of the audible and the visual formats.

10. The system of claim 7, wherein the comparison module generates a summary of the speed/acceleration profiles of subsequent vehicle maneuvers before exiting the system.

11. The system of claim 10, wherein the summary generated at the end is provided using at least one of:
visual display;
audible feedback; or
a combination of the visual display and the audible feedback.

12. The system of claim 7, wherein the in-vehicle fuel economy improvement system is deactivated either upon:
exceeding the speed threshold limit; or
manual deactivation.

13. A vehicular fuel economy training system, the system comprising:
an interactive module configured to send an instruction set for an initial maneuver, and also configured to initiate subsequent vehicular maneuvers;
a calculating module configured to calculate the fuel economy during initial and subsequent vehicle maneuvers;
a computing module configured to consequently generate an optimized speed/acceleration profile based on fuel economy during the initial maneuver, and
to generate speed/acceleration profiles based on fuel economy during subsequent vehicular maneuvers; and
a comparison module configured to compare the subsequent speed/acceleration profiles to the optimized speed/acceleration profile by generating corrective feedbacks through a feedback interface during subsequent maneuvers upon deviations of the subsequent speed/acceleration profiles from the optimized speed/acceleration profile, and thereby summarize the speed/acceleration profiles of the subsequent maneuvers before exiting the training system.

14. The system of claim 13, wherein the feedback interface enables establishment of audio/visual communications.

15. The system of claim 13, wherein the provision of communicating the instruction set and the corrective feedback is carried out using at least one of:
an audible format;
a visual format; or
a combination of the audible and the visual formats.

16. The system of claim 13, wherein the summary obtained at the end is provided using at least one of:
visual display;
audible feedback; or
a combination of the visual display and the audible feedback.

17. The system of claim 13, wherein the in-vehicle fuel economy improvement system is deactivated either upon:
exceeding the speed threshold limit; or
manual deactivation.
